(19) United States
(12) Patent Application Publication
(10) Pub. No.: US 2002/0180566 A1
(43) Pub. Date: Dec. 5, 2002

(54) Dielectric filter improved in inductive coupling

(75) Inventor: Byoung-Jun Yim, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SAMSUNG ELECTRO-MECHANICS CO., LTD.

(21) Appl. No.: 09/905,916

(22) Filed: Jul. 17, 2001

(30) Foreign Application Priority Data
May 30, 2001 (KR) 2001-30170

(51) Int. Cl. H01P 1/202

(52) U.S. Cl. 333/202; 333/206

(57) ABSTRACT

Disclosed is a dielectric filter with improvement in inductive coupling. It comprises a filter body, input-output pad, and an inductive coupling portion. The filter body comprises a block of a dielectric material having top, bottom and grounding surfaces, and having a plurality of through-holes extending from the top to the bottom surfaces defining resonators. The surfaces are substantially covered with a conductive material with the exception that the top surface is uncoated at partial regions around the holes and that one of the grounding surfaces is uncoated at partial regions adjoining the top surface and the bottom surface. The input-output pads are formed on the grounding surface at regions adjoining the top surface, the regions being separated by the uncoated regions adjoining the top surface. Formed on the uncoated region adjoining the bottom surface, the inductive coupling portion has a predetermined length and a predetermined width, the uncoated region being located between the projection sites formed when the outermost holes of the holes are projected at right angles onto the grounding surface. The width is larger at the opposite ends than between the ends. The formation of the uncoated, inductive coupling portion enables a sufficient bandwidth to be obtained even in miniaturized dielectric blocks.

### BACKGROUND OF THE INVENTION

1. Field of the Invention

The present invention relates, in general, to a dielectric filter with improvement in inductive coupling and, more particularly, to a dielectric filter which can be miniaturized without bandwidth reduction.

2. Description of the Prior Art

Filters function to provide attenuation of signals having frequencies outside of a particular frequency range. As well known, such filters are fabricated from ceramic materials which have two or more resonance holes formed therein.

As a rule, dielectric filters are required to show a minimum insertion loss in a desired frequency range as well as a suitable attenuation ratio for frequencies outside of the desired frequency band.

In order to better understand the background of the invention, a conventional dielectric filter is described in conjunction with drawings.

With reference to FIG. 1, there is shown a conventional dielectric filter. As shown in this perspective view, the conventional dielectric filter has a dielectric block of a dielectric material having top, bottom and grounding surfaces. The dielectric block is coated with a conductive material and comprises at least two λ/4 coaxial type resonance holes 1a which run from the top surface 1 to the opposite bottom surface 3. Around each of the resonance holes 1a on the top surface 1, an uncoated region 1b is established. In the grounding surfaces 2, which are in contact with the top surface 1, there are formed input-output pads 2a and 2d which are respectively surrounded by uncoated regions 2b and 2c, which lie adjacent to the top surface 1.

On the top surface 1, the conventional dielectric filter has an inductive coupling line 1c between the resonance holes 1a. By controlling the length and width of the inductive coupling line 1c, a desired bandwidth can be obtained.

However, this conventional dielectric filter with λ/4 coaxial type resonance holes suffers from the disadvantage that it is difficult to obtain a desired bandwidth by an inductive coupling line. For example, it is more difficult to form inductive coupling lines between the resonance holes as the dielectric filter is miniaturized. Additionally, as shown in FIG. 2, a desired bandwidth (corresponding to 1-2 in FIG. 2) is restrictively secured in a miniaturized dielectric filter.

With reference to FIG. 3, there is shown another dielectric filter. As shown in this perspective view, this dielectric filter has a filter body 10 of a dielectric material having a top surface 14, a bottom surface 16, and side surfaces 18, 20, 22 and 24. The surfaces of the dielectric body are coated with a conductive material, defining a metallized layer. A plurality of through-holes extending from the top 14 to the bottom surface 16, defining resonators, are included. In one side surface 20, a magnetic coupling line 32 is formed. The frequency response is controlled by the overall dimension and location of the magnetic coupling line 32. Particularly, the position of the magnetic coupling line 1 is determined in consideration of the attenuation of signals having frequencies outside of a particular frequency range.

The dielectric filter illustrated in FIG. 3, which is structured under the consideration of attenuating signals having frequencies outside of a particular frequency range, can secure a suitable bandwidth to some extent when the magnetic coupling line 32 is formed with a uniform width. However, three or more resonators are difficult to apply to the conventional dielectric filter. The conventional dielectric filter, if provided with three or more resonators, shows the motion of the bandwidth to low frequencies, which gives rise to an increase in insertion loss.

### SUMMARY OF THE INVENTION

Therefore, it is an object of the present invention to overcome the problems encountered in prior arts and to provide a dielectric filter with such an improvement in inductive coupling that it can secure a desired bandwidth even at a small size.

Based on the present invention, the above object could be accomplished by a provision of a dielectric filter with an improvement in inductive coupling, comprising: a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface; input-output pads formed on the grounding surface at regions adjoining the top surface, the regions being separated by the uncoated regions adjoining the top surface; and a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a conventional dielectric filter;

FIG. 2 is a frequency response characteristic curve of the dielectric filter of FIG. 1;

FIG. 3 is a perspective view showing another conventional dielectric filter;

FIG. 4a is a perspective view showing a dielectric filter in accordance with an embodiment of the present invention;

FIG. 4b is a cross sectional view, taken along the line 2A-2A of FIG. 4a;

FIG. 5 is a detailed view of the first inductive coupling portion of FIG. 4a;

FIGS. 6a to 6c are illustrations for the first inductive coupling portion of FIG. 5;

FIGS. 7a to 7c are illustrations for the second inductive coupling portion useful in a dielectric filter in accordance with another embodiment of the present invention;

FIG. 8 is an equivalent circuit of the dielectric filter of FIG. 4a; and

FIG. 9 is a frequency response characteristic curve of a duplexer fabricated from the dielectric filter of FIG. 4a.

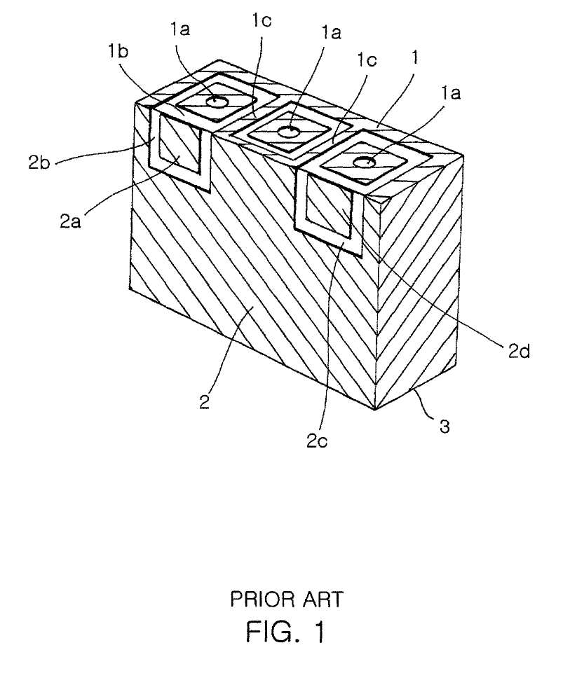

### DETAILED DESCRIPTION OF THE PREFERRED EMBODIMENTS

The application of the preferred embodiments of the present invention is best understood with reference to the accompanying drawings, wherein like reference numerals are used for like and corresponding parts, respectively.

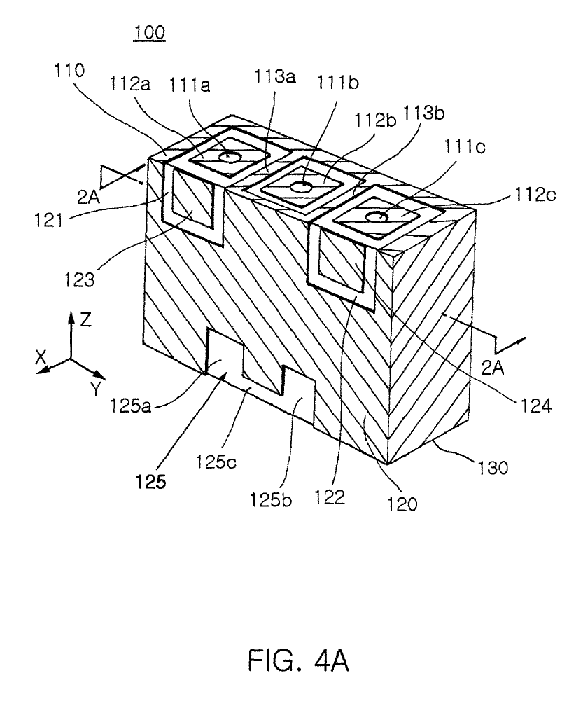

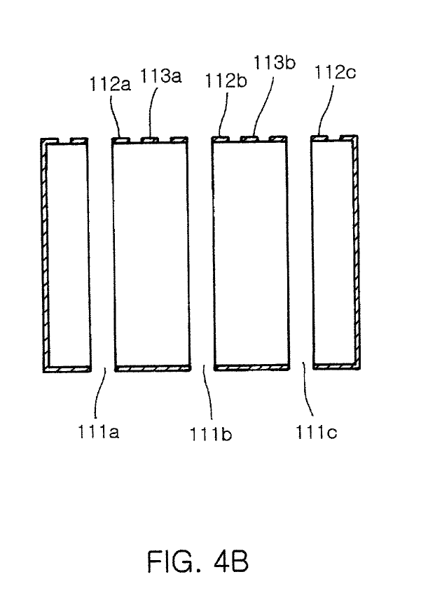

Referring to FIGS. 4a and 4b, there is shown a dielectric filter 100 in a perspective view and a cross sectional view, taken along the line 2A-2A, respectively, in an embodiment of the present invention. As seen in these figures, the dielectric filter 100 has a dielectric block having a top surface 110, a bottom surface 130, and grounding surfaces 120. The surfaces are substantially covered with a conductive material with the exception that the top surface has uncoated regions. A plurality of resonators 111a, 111b, and 111c each of which extents from the top surface 110 to the bottom surface 130 are provided to the dielectric filter. Also, the dielectric filter 100 comprises a filter body comprising a block of a dielectric material in which the top surface 110 has uncoated regions around the resonators 111a, 111b and 111c; input-output pads formed on the grounding surface 120 and separated from the coated regions of the grounding surface 120 by uncoated regions adjoining the top surface 110; and a first inductive coupling portion 125 with predetermined dimensions formed at an uncoated region adjacent to the bottom surface 130 on the grounding surface 120 between the resonator projection sites to which the outermost resonators 111a and 111c out of the resonators 111a, 111b and 111c are projected at right angles. The first inductive coupling portion 125 may have a predetermined length and different widths. In this case, as shown in FIG. 4, the width at the opposite end regions may be larger than that therebetween.

Additionally, the first inductive coupling portion 125 may comprise uncoated, main coupling regions 125a and 125b, which occupy larger areas in the resonator projection regions of the grounding surface, to which the resonators are projected at right angles; and an uncoated, sub-coupling line 125c which occupies the smaller area in the resonator projection regions, connecting the main coupling regions to each other.

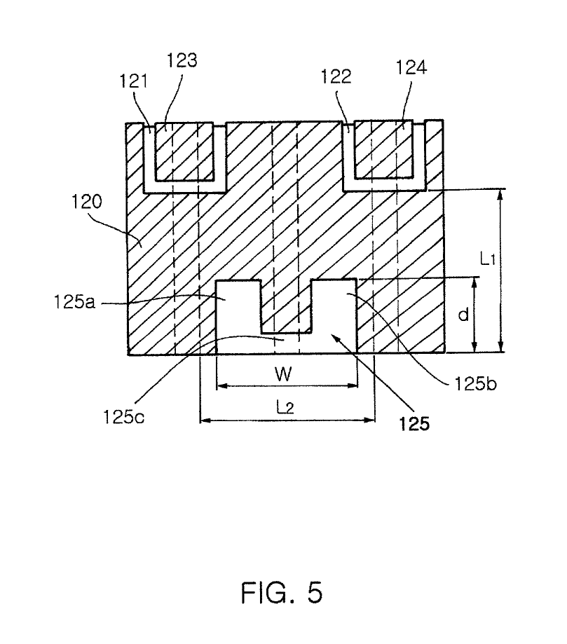

With reference to FIG. 5, the first inductive coupling is shown in detail. On the grounding surface 120 of the dielectric block, as shown in this figure, the width between the resonators 111a and 111c is defined as L2 while the length from the bottom of the electrode pad 123 or 124 to the bottom of the grounding surface 120 is defined as L1. In the area defined by L1 and L2, the first conductive coupling portion 125 is formed. In order to further increase the inductive coupling between the resonators, the first conductive coupling portion 125 is preferably formed to have a dimension of lengthwise non-uniform distances d and a widthwise width w in proximity to the bottom surface 130 within the area defined by L1 and L2.

Returning to FIG. 4, the first inductive coupling portion comprises main coupling regions 125 and 125b with a predetermined area, which correspond respectively to the uncoated grounding surface regions between adjacent ones among the resonator projection regions on the grounding surface 120, to which the resonators 111a, 111b and 111c are projected, that is, the uncoated grounding surface regions between the projection regions of the resonators 111a and 111b and between the projection regions of the resonators 111b and 111c, and an uncoated sub-coupling line 125c interconnecting the proximal sides among the main coupling regions 125a and 125b. In the accompanying drawings, the resonator region is represented by a dotted line.

Through the repeated fabrication and testing of the first inductive coupling portion 125 consisting of the main coupling regions 125a and 125b and the sub-coupling ling 125c, the main coupling regions 125a and 125b was found to have great influence on the inductive coupling. Also, the inductive coupling is affected by the sub-coupling line 125c. Herein, if the area of the sub-coupling line 125c becomes as large as that of the main coupling region 125a or 125b, that is, if the first inductive coupling portion 125 has a uniform width (d), band motion occurs. Accordingly, each of the main coupling regions 125a and 125b of the first inductive coupling portion 125 is preferably larger in area than the sub-coupling line 125c in order to give a minimum insertion loss in a desired band without band motion. Herein, controlling the areas of the main coupling regions 125a and 125b enables the inductive coupling to be modulated with concomitant control of the insertion loss within a desired bandwidth.

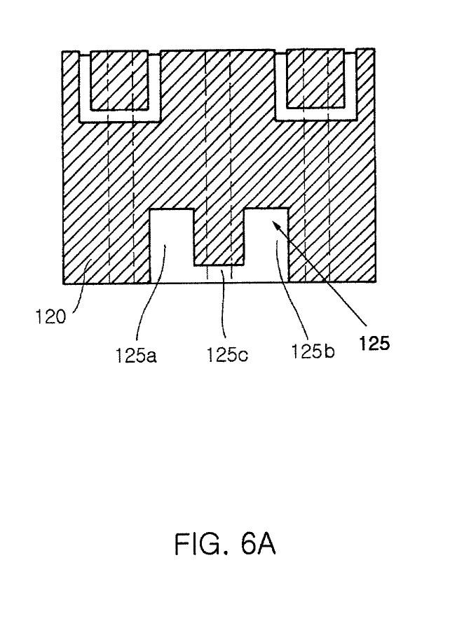

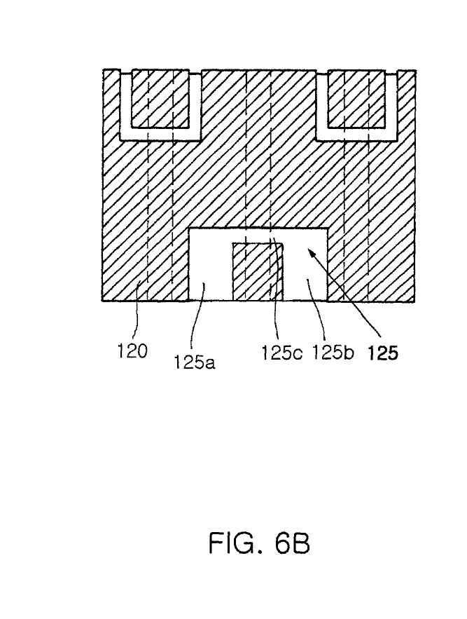

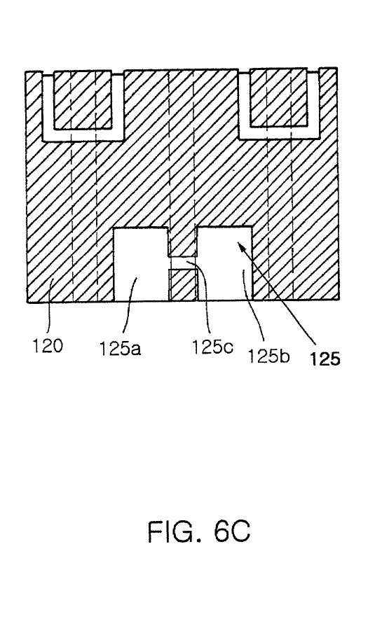

With reference to FIGS. 6a to 6c, there are examples of the first inductive coupling portion of FIG. 5. As seen in the illustrations, the first inductive coupling portion 125 comprising the main coupling regions 125a and 125b and the sub-coupling line 125c may be modified to diverse shapes within the scope of the present invention. For example, the first inductive coupling portion 125 can be formed into “U”, inverted “U”, and “H” forms.

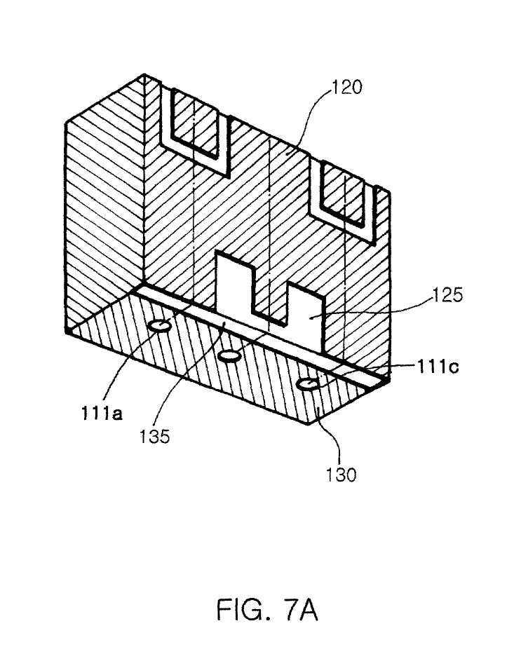

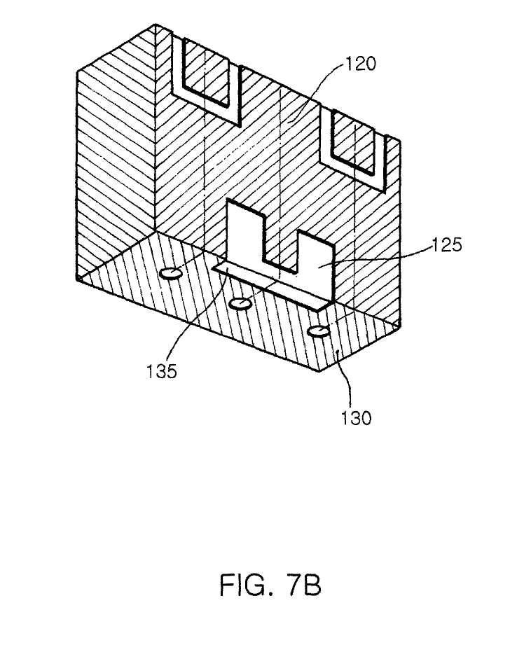

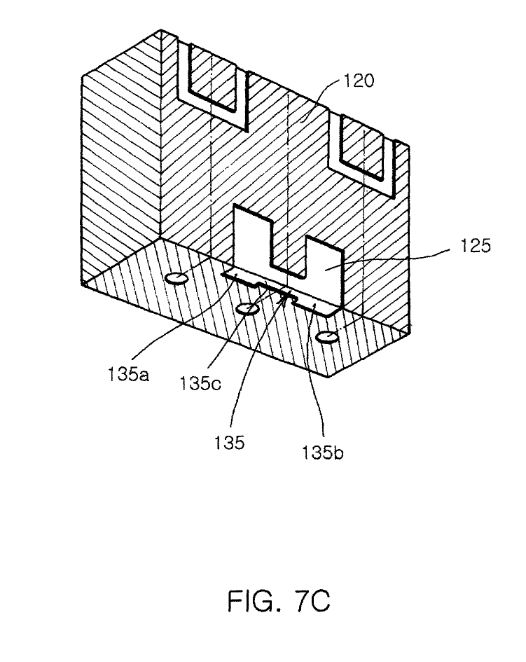

In accordance with an aspect of the present invention, the dielectric filter 100 further comprises at least one second inductive coupling portion 135 formed on the bottom surface 130 at an uncoated region adjoining the grounding surface 120 in the dielectric block, as shown in FIG. 7.

Examples of the second inductive coupling portions useful in the present invention are illustrated in FIGS. 7a to 7c. As seen in these figures, the second inductive coupling portion 135 is formed at a region on the bottom area 130, adjoining the grounding area 120. In order to increase the inductive coupling, the second inductive coupling portion 135 is preferably formed within the defined region such that it adjoins the first inductive coupling portion 125.

As illustrated in FIGS. 7a to 7c, the second inductive coupling portion 135 is uniform or non-uniform in width. For example, it may be formed into a square with a uniform width as shown in FIGS. 7a and 7b or with non-uniform widths as shown in FIG. 7c. In the case of FIG. 7c, the second inductive coupling portion 135 may be divided into uncoated, larger area regions 135a and 135b and an uncoated, smaller area region 135c. In this regard, the second inductive coupling portion 135 may be formed into various shapes, such as “U”, inverted “U”, “H”, “┐”, inverted “┐”, “└” and inverted “└”.

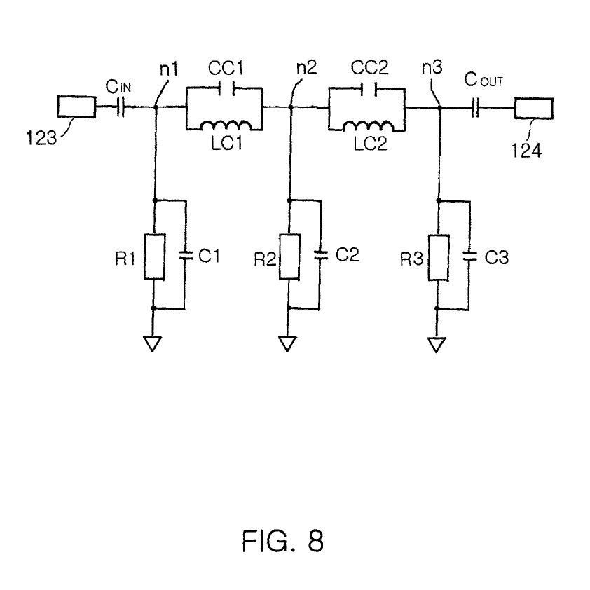

Turning now to FIG. 8, there is shown an equivalent circuit of the dielectric filter of FIG. 4a. In the FIG. 8, reference numerals 123 and 124 denote the input pad and the output pad of FIG. 4a, respectively. Cᵢₙ is defined by the distance between the input pad 123 and the resonator 111a while Cₒᵤₜ is defined by the distance between the output pad 124 and the resonator 111c. Located between grounds and nodes n1, n2 and n3, R1, R2 and R3, each comprising an inductor and a capacitor, which are connected in parallel, are defined by the diameters and lengths of the resonators 111a, 111b and 111c, respectively. C1, C2 and C3 are defined by the widths of the uncoated regions around the resonators 111a, 111b and 111c on the top surface, that is, the distances between the loading capacitor patterns 112a, 112b and 112c of the resonators 111a, 111b and 111c and the grounded surface. CC1 and CC2 are defined by the coupling equivalent to the formation of electric fields between the resonators 111a and 111b and between the resonators 111b and 111c, respectively. LC1 and LC2 are defined by the coupling equivalent to the formation of magnetic fields between the resonators 111a and 111b and between the resonators 111b and 111c, respectively, which are under the influence of the first 125 and the second inductive coupling portion 135.

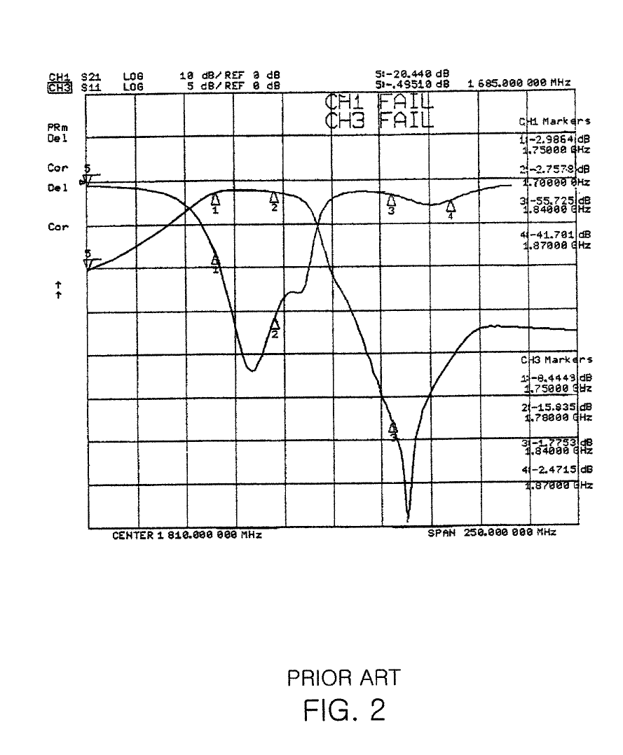

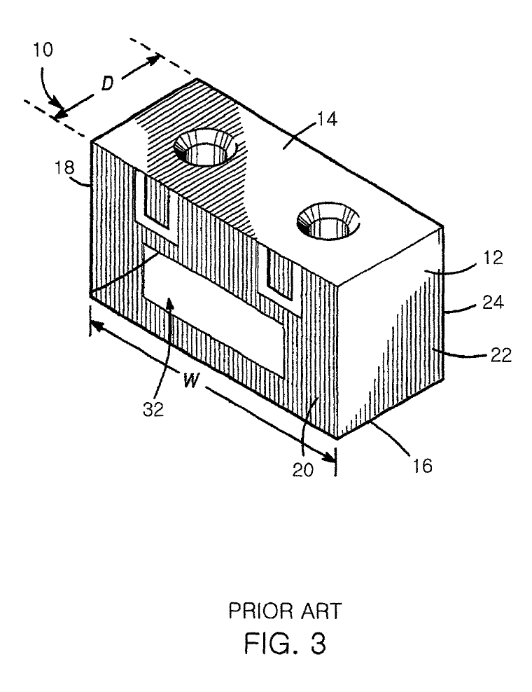

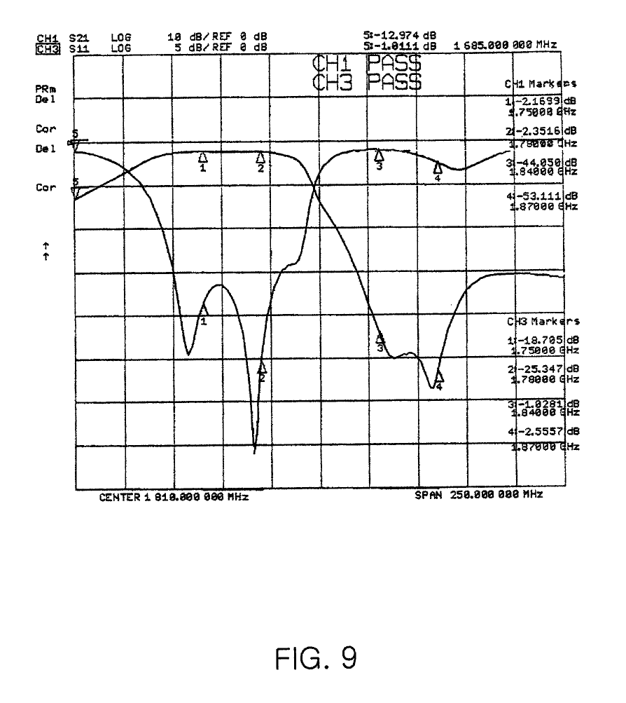

With reference to FIG. 9, there is a frequency response characteristic curve of a duplexer fabricated from the dielectric filter of FIG. 4a. As apparent in the curve, the duplexer fabricated from the dielectric filter of the present invention shows insertion loss lower than that of FIG. 2 (1-2). Thus, a bandwidth with a desired insertion loss can be obtained in the dielectric filter of the present invention.

As described hereinbefore, a sufficient bandwidth can be obtained even in miniaturized dielectric blocks by forming the uncoated, first inductive coupling portion on the grounding surface adjoining the bottom surface, in accordance with the present invention.

In addition to the first inductive coupling portion, the formation of an additional uncoated inductive coupling portion on the bottom surface at a region adjoining the grounding surface enables the dielectric filter to be further miniaturized while securing a sufficient bandwidth.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A dielectric filter with an improvement in
inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface;
input-output pads formed on the grounding surface at regions adjoining the top surface, the regions being separated by the uncoated regions adjoining the top surface; and
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends.

2. The dielectric filter as set forth in claim 1, wherein the first inductive coupling portion comprises:
main coupling regions formed on the grounding surface between the adjacent ones of the projection sites formed when the holes are projected at right angles onto the grounding surface; and
a sub-coupling line interconnecting proximal sides of the main coupling regions.

3. The dielectric filter as set forth in claim 2, wherein each of the main coupling regions of the first inductive coupling portion is larger in area than the sub-coupling line.

4. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface;
input-output pads formed on the grounding surface at regions adjoining the top surface, the regions being separated by the uncoated regions adjoining the top surface; and
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends, wherein the first inductive coupling portion comprises main coupling regions of a larger width formed on the grounding surface between the adjacent ones of the projection sites formed when the holes are projected at right angles onto the grounding surface, and a sub-coupling line of a smaller width interconnecting proximal sides of the main coupling regions.

5. The dielectric filter as set forth in claim 4, wherein each of the main coupling regions of the first inductive coupling portion is larger in area than the sub-coupling line.

6. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface and with an additional exception that the bottom surface is uncoated at a partial region adjoining the grounding surface;
input-output pads formed on the grounding surface at regions adjoining the top surface, the regions being separated by the uncoated regions adjoining the top surface;
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends; and
a second inductive coupling portion formed on the bottom surface at the uncoated region adjoining the grounding surface.

7. The dielectric filter as set forth in claim 6, wherein the first inductive coupling portion comprises:
main coupling regions with a large width formed on the grounding surface between the adjacent ones of the projection sites formed when the holes are projected at right angles onto the grounding surface; and
a sub-coupling line with a small width interconnecting proximal sides of the main coupling regions.

8. The dielectric filter as set forth in claim 7, wherein each of the main coupling regions of the first inductive coupling portion is larger in area than the sub-coupling line.

9. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface and with an additional exception that the bottom surface is uncoated at a partial region adjoining the grounding surface;
input-output pads formed on the grounding surface at regions adjoining the top surface, the regions being separated by the uncoated regions adjoining the top surface;
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends, wherein the first inductive coupling portion comprises main coupling regions of a larger width formed on the grounding surface between the adjacent ones of the projection sites formed when the holes are projected at right angles onto the grounding surface, and a sub-coupling line of a smaller width interconnecting proximal sides of the main coupling regions; and
a second inductive coupling portion formed on the bottom surface at at least one uncoated region adjoining the grounding surface.

10. The dielectric filter as set forth in claim 9, wherein each of the main coupling regions of the first inductive coupling portion is larger in area than the sub-coupling line.

11. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface;
input-output pads formed on the grounding surface at regions adjoining the top surface, the regions being separated by the uncoated regions adjoining the top surface; and
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface and consisting of large areas at opposite ends and a smaller area between the opposite ends.

12. The dielectric filter as set forth in claim 11, wherein the first inductive coupling portion comprises:
main coupling regions with a large width formed on the grounding surface between the adjacent ones of the projection sites formed when the holes are projected at right angles onto the grounding surface; and
a sub-coupling line with a small width interconnecting proximal sides of the main coupling regions.

13. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface;
input-output pads formed on the grounding surface at regions adjoining the top surface, the regions being separated by the uncoated regions adjoining the top surface; and;
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, wherein the first inductive coupling portion comprises main coupling regions of a larger width formed on the grounding surface between the adjacent ones of the projection sites formed when the holes are projected at right angles onto the grounding surface, and a sub-coupling line of a smaller width interconnecting proximal sides of the main coupling regions.

14. The dielectric filter as set forth in claim 13, wherein the first inductive coupling portion has non-uniform widths, in which the width of each of the main coupling regions is larger than that of the sub-coupling line.

15. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface and with an additional exception that the bottom surface is uncoated at a partial region adjoining the grounding surface;
input-output pads formed on the grounding surface at regions adjoining the top surface, the regions being separated by the uncoated regions adjoining the top surface;
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface and consisting of large areas at opposite ends and a smaller area between the opposite ends; and.
a second inductive coupling portion formed on the bottom surface at at least one uncoated region adjoining the grounding surface.

16. The dielectric filter as set forth in claim 15, wherein the first inductive coupling portion comprises:
main coupling regions with a large width formed on the grounding surface between the adjacent ones of the projection sites formed when the holes are projected at right angles onto the grounding surface; and
a sub-coupling line with a small width interconnecting proximal sides of the main coupling regions.

17. A dielectric filter with an improvement in inductive coupling, comprising:
a filter body comprising a block of a dielectric material having top, bottom and grounding surfaces, and having a plurality of through-holes extending from the top to the bottom surfaces defining resonators, the surfaces being substantially covered with a conductive material with the exception that the top surface is uncoated at partial regions around the holes and that one of the grounding surfaces is uncoated at partial regions adjoining the top surface and the bottom surface and with an additional exception that the bottom surface is uncoated at a partial region adjoining the grounding surface;
input-output pads formed on the grounding surface at regions adjoining the top surface, the regions being separated by the uncoated regions adjoining the top surface;
a first inductive coupling portion, formed on the uncoated region adjoining the bottom surface, and having a predetermined length and a predetermined width, the uncoated region being located between the projection sites formed when the outermost holes of the holes are projected at right angles onto the grounding surface, the width being larger at the opposite ends than between the ends, wherein the first inductive coupling portion comprises main coupling regions with large areas formed on the grounding surface between the adjacent ones of the projection sites formed when the holes are projected at right angles onto the grounding surface, and a sub-coupling line with a small area interconnecting proximal sides of the main coupling regions; and
a second inductive coupling portion formed on the bottom surface at at least one uncoated region adjoining the grounding surface.

18. The dielectric filter as set forth in claim 17, wherein the first inductive coupling portion has non-uniform widths, in which the width of each of the main coupling regions is larger than that of the sub-coupling line.
